(19) United States
(12) Patent Application Publication
(10) Pub. No.: US 2014/0298621 A1
(43) Pub. Date: Oct. 9, 2014

(54) CORD LOCK ASSEMBLY AND METHODS OF UTILIZING SAME

(71) Applicant: ROBERT ANFUSO, Matawan, NJ (US)

(72) Inventor: ROBERT ANFUSO, Matawan, NJ (US)

(21) Appl. No.: 14/201,571

(22) Filed: Mar. 7, 2014

Related U.S. Application Data
(60) Provisional application No. 61/774,373, filed on Mar. 7, 2013.
(60) Provisional application No. 61/835,526, filed on Jun. 14, 2013.

(51) Int. Cl. F16G 11/03; F16G 11/10

(52) U.S. Cl. CPC F16G 11/03; F16G 11/10
USPC 24/115 G

(57) ABSTRACT

Cord lock assemblies and methods of utilizing are provided. In some embodiments, a cord lock assembly is provided that may comprise: a bullet casing comprising an opening; a caming device comprising a shaft having a hole formed therethrough, the hole comprising the same size as the opening in the bullet casing, the hole adapted to accept a cord; a rod attached to the caming device, the rod for moving the caming device between an open position and a closed position; a button comprising a bullet primer, the button attached to the rod; a spring for biasing the cam in the closed position until the rod is depressed by a user; and a bullet head attached the casing.

### CROSS-REFERENCE TO RELATED APPLICATIONS

The present application claims priority to U.S. Provisional Patent Application Ser. No. 61/774,373 entitled “Cord Lock Assembly and Methods of Utilizing Same,” filed Mar. 7, 2013, and claims priority to U.S. Provisional Patent Application Ser. No. 61/835,526 entitled “Cord Lock Assembly and Methods of Utilizing Same,” filed Jun. 14, 2013 the disclosures of which are incorporated herein by reference in their entireties

### BACKGROUND

1. Field of the Invention

Embodiments of the present invention are generally related to a cord lock assembly and methods of utilizing the same. More specifically, embodiments of the present invention relate to a cord lock assembly that may include real ammunition parts for substantially locking the movement of an item passing through the cord lock.

2. Description of Related Art

Ammunition casings, components, and the like are often discarded after use. Many times these casings and components are not and/or cannot be recycled. Discarding large amounts of ammunition components may contribute to pollution of the earth and may be detrimental to the environment. As such, a need exits for an apparatus comprising ammunition components to decrease the detrimental environmental impact of discarded ammunition components, or the like.

### SUMMARY

Embodiments of the present invention are generally related to a cord lock assembly and methods of utilizing the same. More specifically, embodiments of the present invention relate to a cord lock assembly that may include real ammunition parts for substantially locking the movement of an item passing through the cord lock.

In one embodiment of the present invention, a cord lock assembly is provided that may comprise: a bullet casing comprising an opening; a caming device comprising a shaft having a hole formed therethrough, the hole comprising the same size as the opening in the bullet casing, the hole adapted to accept a cord; a rod attached to the caming device, the rod for moving the caming device between an open position and a closed position; a button comprising a bullet primer, the button attached to the rod; a spring for biasing the cam in the closed position until the rod is depressed by a user; and a bullet head attached the casing.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a front view of a cord lock assembly in accordance with one embodiment of the present invention;

FIG. 2 depicts a perspective view of a cord lock assembly in accordance with one embodiment of the present invention;

FIG. 3 depicts an exploded view of a cord lock assembly in accordance with one embodiment of the present invention;

FIG. 4 depicts a front view of two sizes of cord lock assemblies in accordance with one embodiment of the present invention;

FIG. 5 depicts a front view of various sizes and parts of cord lock assemblies in accordance with one embodiment of the present invention;

FIG. 6 depicts views of a cord lock assembly with a fire starting means in accordance with embodiments of the present invention;

FIG. 7 depicts an exploded view of a cord lock assembly with electronic components in accordance with embodiments of the present invention;

FIG. 8 depicts a cross-sectional side view of a cord lock assembly in accordance with embodiments of the present invention;

FIG. 9 depicts a cross-sectional perspective view of a cord lock assembly in accordance with embodiments of the present invention;

FIG. 10 depicts a side view of a casing and a rod of an exemplary cord lock assembly in accordance with embodiments of the present invention;

FIG. 11 depicts a plan view of a casing and a rod of an exemplary cord lock assembly in accordance with embodiments of the present invention;

FIG. 12 depicts a side view of a caming device and a rod of an exemplary cord lock assembly in accordance with embodiments of the present invention;

FIG. 13 depicts a side view of a casing and tops of an exemplary cord lock assembly in accordance with embodiments of the present invention;

FIG. 14 depicts a cross-sectional side view of a zipper pull in accordance with embodiments of the present invention;

FIG. 15 depicts a side view of a zipper pull in accordance with embodiments of the present invention;

FIG. 16 depicts a perspective view of the end of a zipper pull in accordance with embodiments of the present invention;

FIG. 17 depicts a front view of a zipper pull in accordance with embodiments of the present invention; and

FIG. 18 depicts a front view of a zipper pull in accordance with embodiments of the present invention.

The headings used herein are for organizational purposes only and are not meant to be used to limit the scope of the description or the claims. As used throughout this application, the word ^{may} is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to a cord lock assembly and methods of utilizing the same. More specifically, embodiments of the present invention relate to a cord lock assembly that may include ammunition parts for substantially locking the movement of an item passing through the cord lock. .

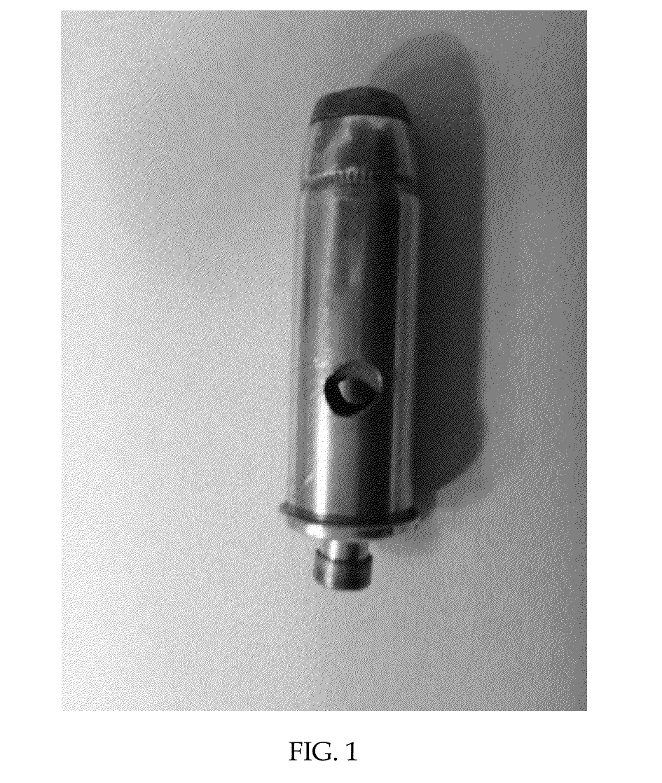

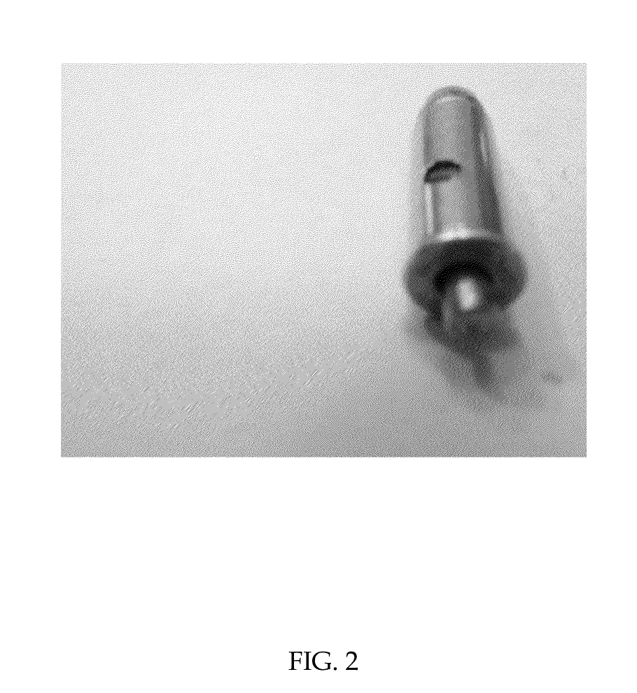

FIGS. 1 and 2 depict views of a cord lock assembly in accordance with one embodiment of the present invention. In some embodiments, the cord lock assembly may comprise a casing, a rod, a caming device, a spring, a head, and a primer. In some embodiments, the cord lock assembly generally comprises real components of working ammunition, excluding gun power and a live primer. In some embodiments, the cord lock may comprise parts from real ammunition that has been fired/used, wherein the gunpowder has been expended and/or removed. Alternatively, the cord lock assembly may comprise parts from real ammunition that has not been fired/used, but has never come into contact with gunpowder. In yet another alternative embodiment, the cord lock assembly may comprise elements shaped like parts of ammunition.

In some embodiments of the present invention, the casing may comprise a bullet casing, a material substantially in the shape of a bullet casing, or the like. In some embodiments of the present invention, the head may comprise a bullet head, or a material substantially in the shape of a bullet head, or the like. In some embodiments of the present invention, the primer may comprise a bullet primer, or a material substantially in the shape of a bullet primer, or the like. To assemble the cord lock assembly, the components may be compressed together, similar to the way real bullets with gunpowder are made, to form the completed cord lock assembly. Components that may comprise real ammunition parts may include the bullet casing, the bullet head, and the primer/button. A cord lock assembly can be made out of any caliber ammunition and/or many different finishes of metal. For example, a cord lock assembly may comprise, brass, nickel, chrome, copper, lead, gilding metal, cupronickel, alloys, steel, or the like. Cord lock assemblies in accordance with embodiments of the present invention may comprise a rod for actuating a caming device, the rod attached to a button comprising a real primer.

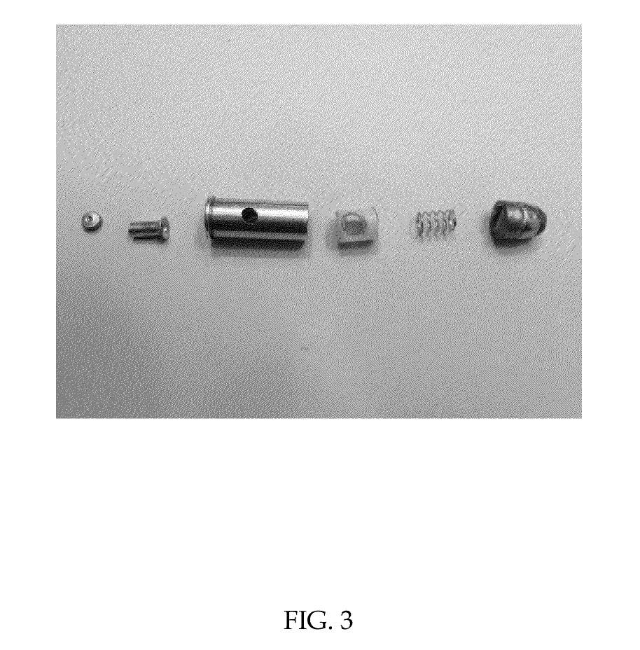

FIG. 3 depicts an exploded view of a cord lock assembly in accordance with one embodiment of the present invention. The exploded view depicts components that may make up the cord lock assembly, namely, the casing, the rod, the caming device, the spring, the bullet head, and the button. The components are depicted in an exploded and disassembled view. In some embodiments of the present disclosure, the caming device and the spring are housed in the casing, and the bullet head seals the caming device and the spring within the casing. The rod may be coupled with the button on one end and with the caming device on another end. The button may comprise a primer from real ammunition or an apparatus formed in the appearance of a primer. The primer may comprise a metallic or plastic casing that is made to fit within the firing chamber of a firearm.

The caming device may comprise a metal or plastic shaft with a hole formed therethrough, wherein the hole is substantially the same size as a hole in the casing and adapted to accept an item. In some embodiments, when the button is compressed, the rod plunges into an aperture at the base of the casing and actuates the caming device. The rod may be coupled with and/or attached to the caming device. When the caming device is actuated, the hole in the caming device substantially lines up with the hole in the bullet casing, thereby allowing an item to easily pass through the casing and the caming device. When the button is released, the spring forces the rod to partially receed out of the aperture at the base of the casing and pulls the caming device back. When the caming device is pulled back, the item passing therethrough is pulled against an edge of the hole in the casing, and is thereby substantially locked into position by the caming device and the force of the spring.

In some embodiments of the present invention, the casing may comprise a real bullet casing. The bullet casing may have been fired. In some embodiments, the bullet casing may not have been fired, and may have never come into contact with gunpowder. In some embodiments, the bullet casing may not be a functional bullet casing, but instead comprise the shape of the bullet casing. The bullet casing may comprise a chamber and/or cylinder adapted to house a caming device and a spring, and a portion of a rod. The bullet casing may have a hole formed on opposing sides adapted for allowing an item to pass therethrough. The bullet casing may also have an aperture formed at the center of the bottom of the casing for allowing the rod to pass therethrough. The item may comprise a garment cord, a shoestring, a luggage cord, a backpack cord, a keychain cord, a jewelry cord, or the like. In some embodiments, the hole may comprise a round shape. Although depicted as a round hole in the Figures, any shape feasible for accepting a cord is contemplated. The casing may comprise an aperture at the base for accepting a rod/button.

The rod may be coupled with the caming device. The rod may comprise a primer attached to the end opposing the connection to the caming device. The primer may be used to force the rod into the bullet chamber and actuate the caming device, thereby allowing the item to pass through the holes in the caming device and the bullet casing. The bullet head may comprise a bullet, and may comprise many sizes and finishes. The bullet head may comprise a lead bullet, or the like. The bullet head may alternatively comprise an apparatus formed in the shape of a bullet. The bullet head may be adapted to seal one end of the bullet casing, thereby sealing the caming device and spring within the bullet casing in accordance with exemplary embodiments. In exemplary embodiments, the caming device may comprise metal and/or plastic. In some embodiments, the interior of the bullet casing may comprise a track adapted to guide the caming device and prevent the caming device from moving in an undesired direction. For example, the track may be adapted to prevent the caming device from moving a number of degrees in a rotational direction.

The spring may be adapted to bias the caming device to a side of the interior of the bullet casing thereby locking an item into place when the item is disposed within the hole of the casing and the hole of the caming device. When the button/rod is depressed, the spring contracts and the hole of the casing and the hole of the caming device align, thereby allowing an item to pass through.

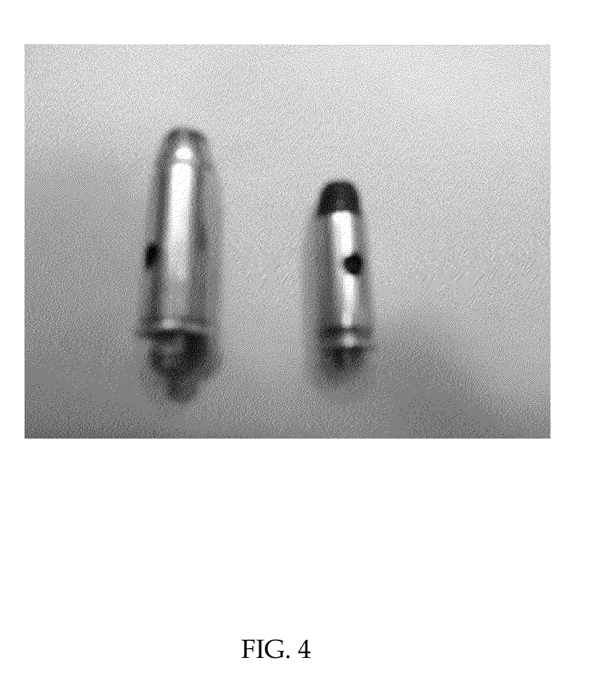

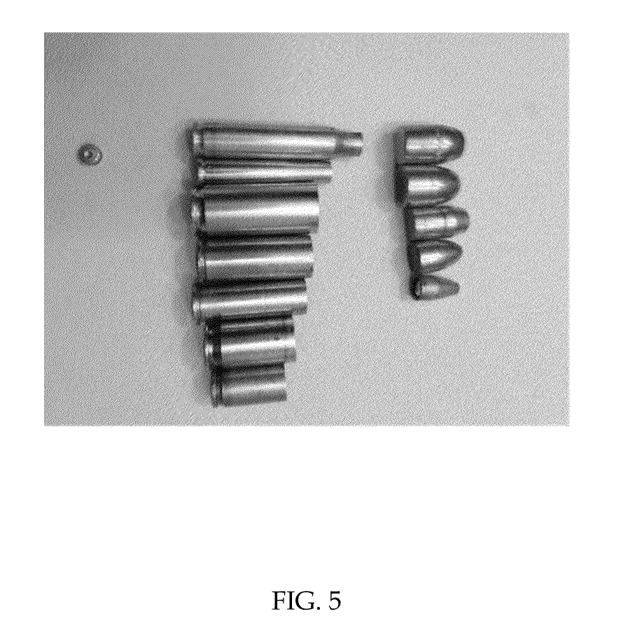

FIGS. 4-5 depict a front view of various sizes and parts of cord lock assemblies in accordance with one embodiment of the present invention. Casings of various sizes may be used with the present invention. For example, casings that may be used can include HM2, 17 HMR, 22LR 4, 22 WMR, 17/23 SMc, 5 mm/35 SMc, 22 Hornet, .223 Remington, .223 WSSM, .243 Winchester, .243 Winchester Improved (Ackley), .25-06 Remington, .270 Winchester, .308 Winchester, .30-06 Springfield, .45-70 Government, .50-90 Sharps casing, and/or the like. Similarly the cord lock assembly may comprise various sizes, finishes, shapes, materials, and/or types of bullet heads.

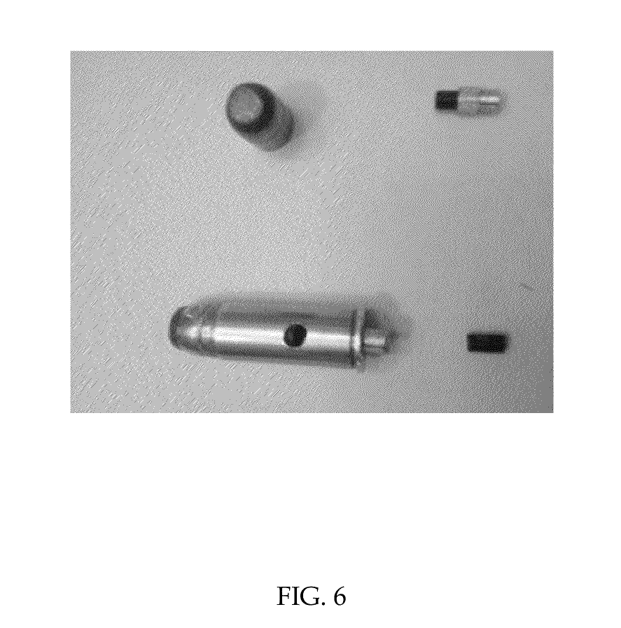

FIG. 6 depicts views of a cord lock assembly with a fire starting means in accordance with embodiments of the present invention. By adding a fire starting means to the cord lock assembly, hunters, campers, outdoorsmen, or the like, would have easy access to a means of starting a fire attached to their jacket and/or clothing. Loose fire starting devices can be easily lost or misplaced. By attaching the fire starting means to the cord lock assembly, the risk of losing the fire starting means would decrease.

In some embodiments, the fire starting means may be attached to a portion of the cord assembly and may be adapted to produce a spark. By way of example, the fire starting means may comprise ferrocerium, a tinder-igniting material, and/or the like. The fire starting means may comprise a material that produces a number of sparks at high temperatures when scraped against a rough surface. In some embodiments, the sparks may have temperatures of approximately 3,000° F. In some embodiments, the fire starting means may be attached to the tip, the base, and/or the primer of the cord lock assembly.

The addition of a fire starting means to the cord lock assembly provide the wearer with the ability to start a fire by scraping the fire starting means on a rough surface. The rough surface may comprise steel, and may create sparks and allow a person to start a fire without matches. As used herein, the term “ferrocerium” may refer to a man-made metallic material that when scraped with any hard, sharp edge, produces sparks that are much hotter than obtained with natural flint and steel, allowing use of a wider range of tinders, and may generally include the terms “mischmetal”, “hot spark”, “metal match”, and “fire steel.” Because ferrocerium can produce sparks when wet and can start hundreds or thousands of fires when used correctly, ferrocerium may be used instead of other fire starting means in some embodiemnts.

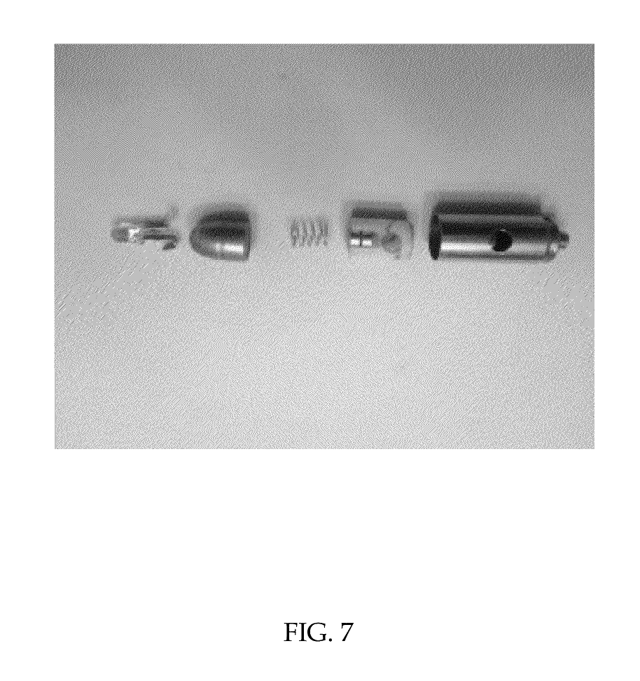

FIG. 7 depicts an exploded view of a cord lock assembly with electronic components in accordance with embodiments of the present invention. In some embodiments of the present invention, electronic components may be included in the cord lock assembly. For example, a circuitry adapted to activate a light may be included. The electronic components may generally be powered by a power source, such as one or more batteries, or the like. A light may be attached to the cord lock, and may be coupled with and/or activated by the circuitry and powered by the one or more batteries. The light may comprise an LED light, an incandescent light, or the like. Each of the one or more batteries may be rechargeable. The light may be activated by a switch, such as a flip switch, a button, a twisting member, or the like.

In some embodiments of the present invention, the light may be adapted to function as a flashlight, thereby enabling the user to view objects in the vicinity of the light in dark environments. The light may be disposed on a portion of the cord lock assembly. For example, the light may be disposed on the tip and/or the base. In some embodiments, the cord lock assembly may be adapted to activate the light when the rod/button is actuated. In some embodiments, the tip of the cord lock assembly may comprise a fire starting means and the base and/or a side of the cord lock assembly may comprise a light. In alternative embodiments, the tip of the cord lock assembly may comprise a light and the base may comprise a fire starting means.

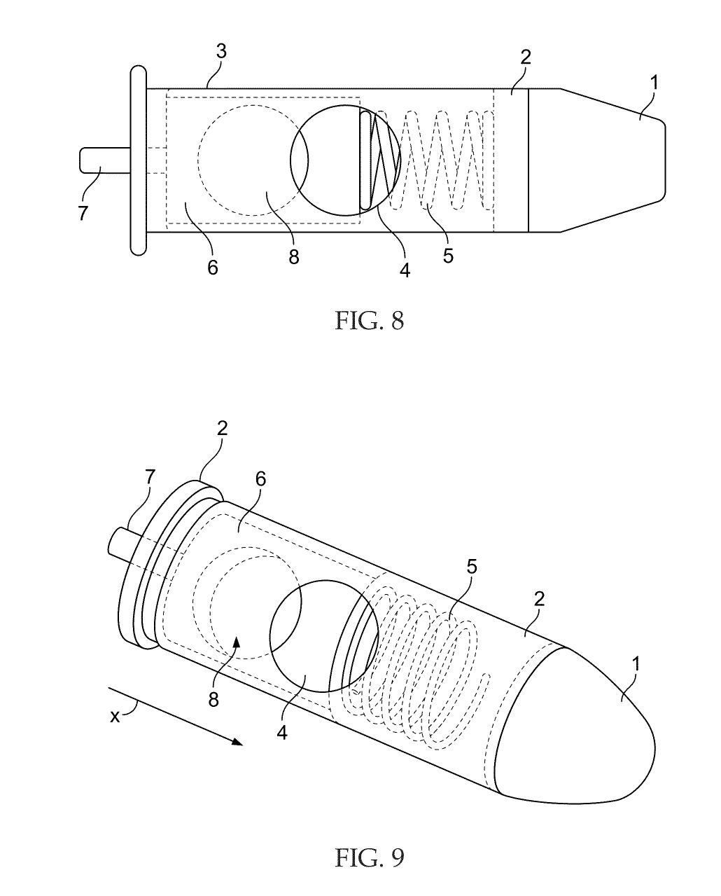

FIGS. 8-9 depict views of a cord lock assembly in accordance with embodiments of the present invention. In exemplary embodiments, a cord lock assembly may comprise a head 1, a casing comprising a top 2 and a bottom 3, an opening 4 in the casing, a spring 5, a caming device 6 and/or member, an opening 8 in the caming device 6, a rod 7, a primer (not shown) at the end of the rod, and/or the like. The head 1 may comprise a bullet head, or the like. The casing may comprise a bullet casing, or the like. The primer may comprise a bullet primer, or the like. The casing top 2 and bottom 3 may comprise an integral casing or may comprise two separate pieces connected together. The head 1, the casing top 2 and bottom 3, the opening 4 in the casing, the spring 5, the caming device 6, the opening 8 in the caming device 6, the rod 7, and the primer in accordance with some embodiments of the present invention are described above with respect to FIGS. 1-8.

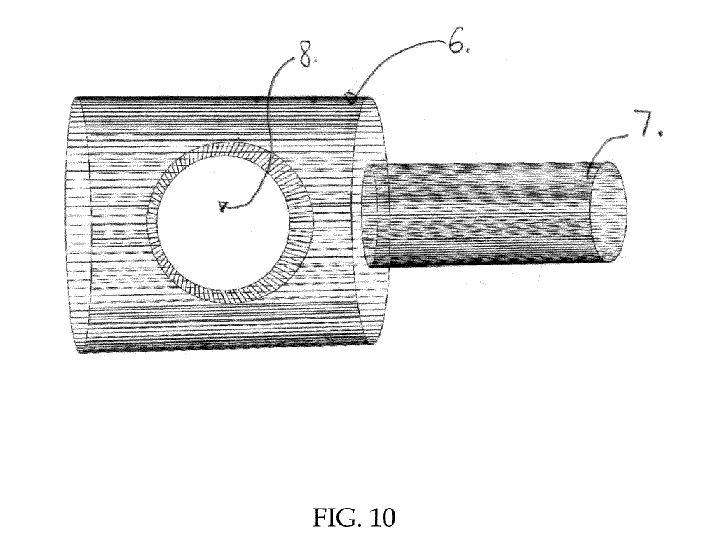

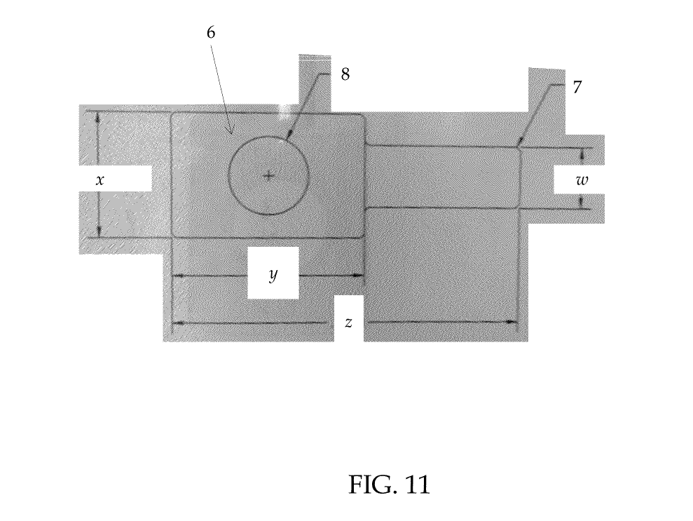

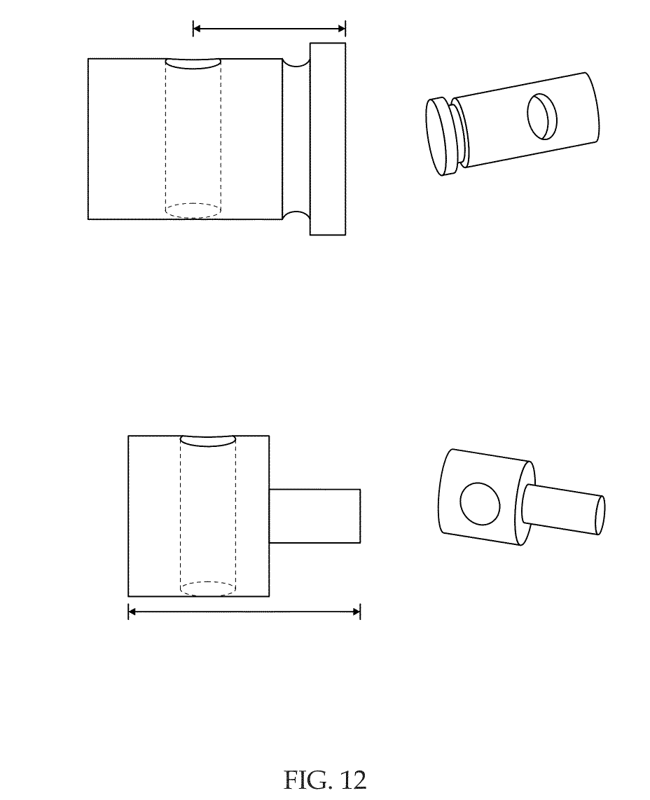

FIGS. 10-12 depict views of a caming device 6 and a rod 7 of an exemplary cord lock assembly in accordance with embodiments of the present invention. The caming device 6 may be connected to the rod 7. In some embodiments, the caming device 6 may be detachably attached to the rod 7. In some embodiments, the caming device 6 and the rod 7 may comprise separate pieces that may be attached via an adhesive, or the like. In some embodiments, the caming device 6 and the rod 7 may be integral. The opening 8 in the caming device 6 may generally be adapted to receive a cord in accordance with embodiments of the present invention.

The width x of the caming device 6 may be of a sufficient size to fit within a casing in accordance with the present invention. For example, the caming device 6 may comprise a width x adapted to fit within a bullet casing, for example, a width of 1/16″- 11/16″, or the like. By way of example, the caming device 6 may comprise a width x of 5/16″. The height y of the caming device 6 may be of a sufficient size to slide within a casing in accordance with the present invention. For example, the caming device 6 may comprise a height y adapted to fit within a bullet casing, for example, a height of 0.2″-0.8″, or the like. By way of example, the caming device 6 may comprise a height y of 0.476″. The rod 7 may comprise a width w adapted to attach to the caming device 6 and fit within a casing in accordance with embodiments of the present invention. In some embodiments, the width w may comprise width w of 0.05″ to 0.3″. For example, the width w may comprise 0.156″. The height z between the base of the caming device 6 and the top of the rod 7 when the rod 7 is fully or partially extended may be sufficient to extend out of a casing and be pressed downwardly by a thumb in accordance with embodiments of the present invention. In some embdodments, the height z may comprise 0.4″-1.6″, or the like. For example, the height z may comprise 0.870″. In some embodiments the caming device 6 and/or the rod 7 may comprise a plastic, a metal, a wood, a glass, a combination thereof, and/or the like. In some embodiments the caming device 6 may comprise brass, aluminum, and/or the like.

In some embodiments, the distance between the end of the casing and the center of the second hole may comprise 0.1″-1″. For example, the distance between the end of the casing and the center of the second hole may comprise ½″. In some embodiments, the length of the rod may comprise 0.1″-1″. For example, the length of the rod may comprise 0.365″, 0.156″, or the like. In some embodiments, the length between a point below the hole in the caming device 6 and the end of the caming device 6 may comprise 0.1″-1″. For example, the length between a point below the hole in the caming device 6 and the end of the caming device 6 may comprise 0.260″, or the like.

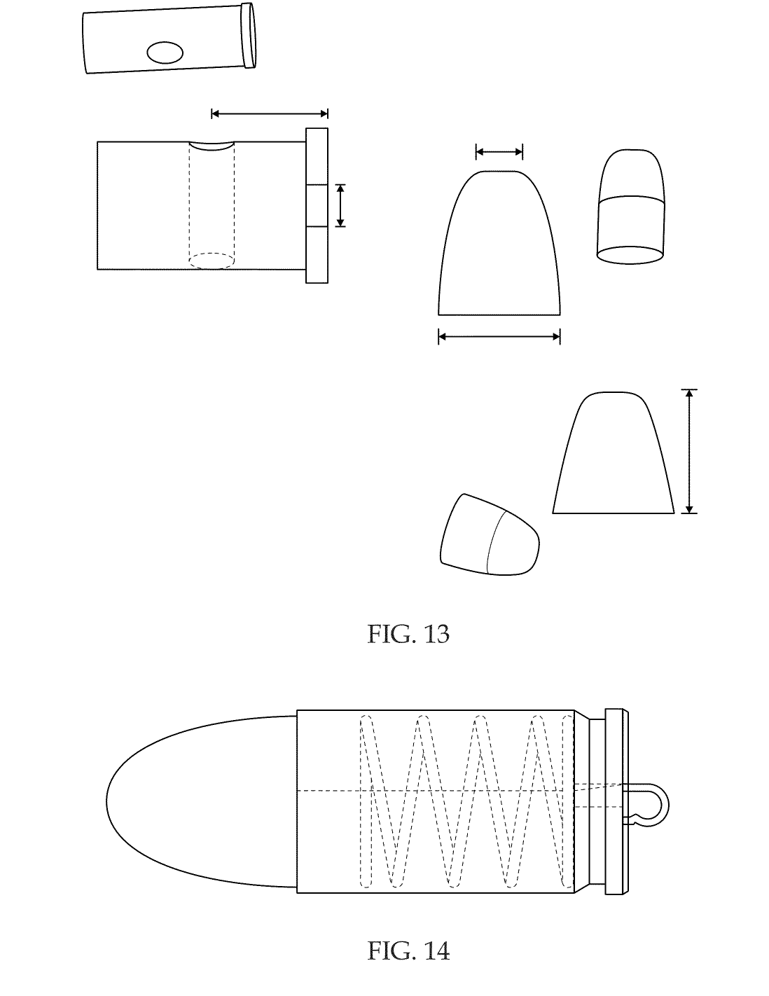

FIG. 13 depicts a side view of a casing, and a top of an exemplary cord lock assembly in accordance with embodiments of the present invention. The casing and the top may be made in accordance with embodiments of the present invention as described herein. A hole in at least one side of the casing may be adapted to receive the caming device. In some embodiments, a second hole in the casing may be adapted to receive a cord in accordance with embodiments with the present invention. In some embodiments the diameter of the second hole may comprise 1/64″- 31/64″, or the like.

For example, the diameter of the second hole may comprise 15/64″. FIG. 13 shows a perspective side view and a top view of a top in accordance with the present invention. In some embodiments, the top may comprise a bullet top. In some embodiments, the height of the bullet top may comprise 10 mm and the width may comprise 9 mm or the like. Alternative sizes and shapes of tops are contemplated by and within embodiments of the present invention. For example, the top may be rounded, square, in a triangle shape, or the like. The top may generally comprise the head of a bullet or a member formed in the shape of a head of a bullet, or the like.

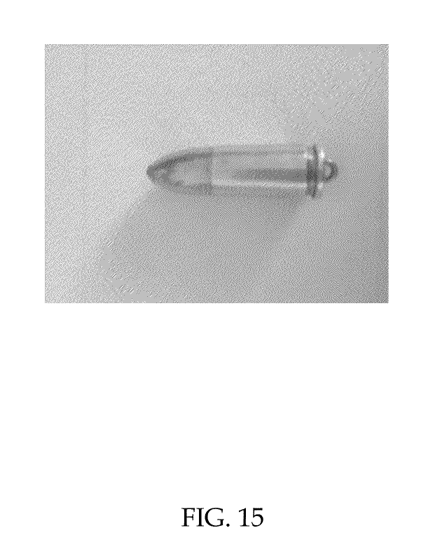

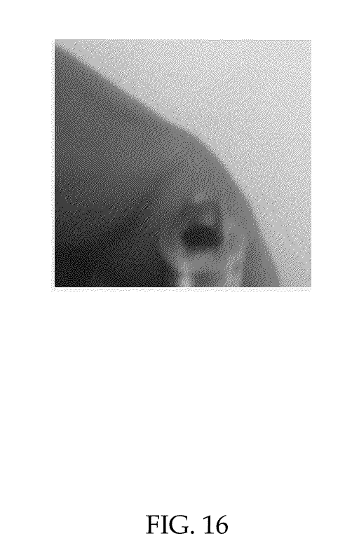

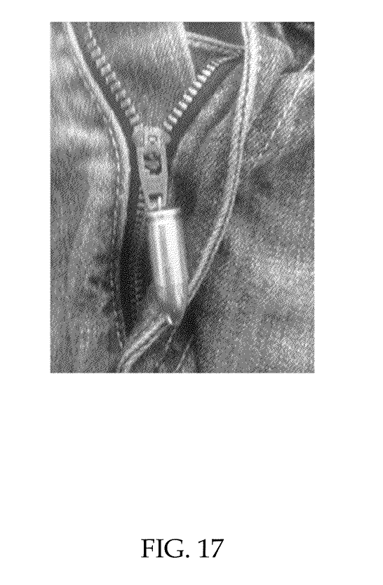

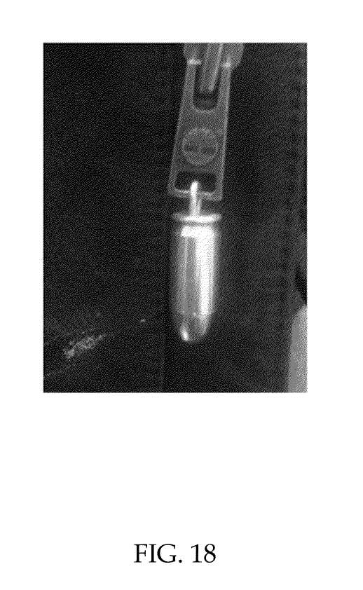

FIGS. 14-18 depict views of a zipper pull in accordance with embodiments of the present invention. In accordance with exemplary embodiments of the present invention, the zipper pull may comprise bullet components and may be adapted to couple with an item having a loop or connection means at one end. For example, the zipper pull may be adapted to couple with the end of a zipper, such that pulling the zipper pull will move the zipper up or down. In exemplary embodiments the zipper pull may comprise a casing, an actuator, and a connection member, and a biasing assembly. The connection member may comprise a hook, and the zipper pull may be adapted to attach to a portion of a zipper when the hook is extended. The connection member may be extended by activating, depressing, and/or pushing the actuator. In exemplary embodiments, the casing may be adapted to house the biasing assembly and couple with the actuator and the connection member. In some embodiments, the biasing assembly may comprise a spring and a rod.

In exemplary embodiments, the actuator may comprise a curved member, such as a bullet head. The actuator may be coupled with the rod and the rod may be coupled with connection member. In some embodiments, the actuator, the rod, and/or the connection member may comprise a unitary piece, or may comprise individual pieces that are connected. In some embodiments the actuator, the rod, and/or the connection member may comprise multiple pieces adapted to be coupled with each other.

In operation, when the actuator is depressed, the actuator may force the connected rod down the interior of the casing, thereby extending the connection member past the end portion of the casing. When the connection member is extended past the end of the casing, a connection space is created for connection of the item. In some embodiments, the connection space may be formed under the bend of the hook. To create the connection space, the end and/or point of the hook may be extended away from the casing so that an item can fit under the point of the hook and toward the shank of the hook.

A spring may be disposed within the casing for creating resistance for the actuator. When the actuator is depressed, the spring within the casing may be depressed and tension may be created in the spring. In some embodiments, when the actuator is released, the stored energy and/or the released tension in the spring in the spring may cause the actuator, the rod, and/or the connection member to retract to their original positions. When the connection member retracts, if an item is in the connection space, the end and/or point of the hook may enclose and/or encircle around the item and may be pressed against a portion of the back of the casing, thereby securing the item within the hook substantially under the bend.

The bullet components may comprise used and/or unused bullet components, or may comprise or members manufactured to look like bullet components. The bullet components may comprise metal, plastic, wood, a solid material, and/ or the like. The types of bullets and/or casings described above with reference to FIGS. 1-7 may also be used for the zipper pull. For example, casings and/or shapes of casings may include HM2, 17 HMR, 22LR 4, 22 WMR, 17/23 SMc, 5 mm/35 SMc, 22 Hornet, .223 Remington, .223 WSSM, .243 Winchester, .243 Winchester Improved (Ackley), .25-06 Remington, .270 Winchester, .308 Winchester, .30-06 Springfield, .45-70 Government, .50-90 Sharps casing, and/ or the like. The zipper pull may comprise various sizes, finishes, shapes, materials, and/or types of bullet components.

In exemplary embodiments, the zipper pull may comprise a head, a casing, a rod, a spring, and a hook member. The head may be adapted to compress the spring and rod attached to the hook member, moving the hook member out past the end of the bullet. When the hook member is moved out past the end of the bullet, the zipper pull may be attached to an item, such as the end of a zipper, or the like, by sliding the item under the hook and releasing the tension in the spring by releasing the bullet head. When the zipper pull is to be removed from the item, the bullet head may be depressed again, compressing the spring and the rod and extending the hook. When the hook is extended, an open side of the hook may allow the item, such as the end of the zipper, to be removed from the zipper pull.

The head may be adapted to be coupled with the rod and the spring. The shaft and the spring may be housed in the casing and attached and/or coupled with the hook member. The rod may comprise an extension of the hook member. The head may comprise a bullet head or a member manufactured in the shape of the bullet head. The bullet head may comprise a metal, a plastic, or any material adapted to couple with a shaft and/or a spring. The casing may comprise any bullet casing, for example, the bullet casings described above. The bullet casing may be substantially hollow, and may be adapted to house a spring and rod and couple with a bullet head and a hook member in accordance with the present invention.

The rod may be adapted to fit within the casing, and may be adapted to secure to the bullet head at one end and the hook member at the other. The rod may comprise sufficient strength to resist breaking when compressed by the bullet head, even when the compression is resisted by the spring. The rod may comprise the same diameter as the hook member or may comprise a different diameter. The rod may generally be disposed in the center of the casing and may extend out to the hook member out the back of the bullet. The spring may comprise sufficient tension to retain an item, such as the end of a zipper, in the hook. The spring may extend from one end of the casing to the other end of the casing, or may comprise a shorter length. The spring may be coupled with, and/or attached to, the rod. The spring may be unattached to other components and may be adapted to fit within the casing. In some embodiments, the spring may be coupled with, attached to, and/or disposed on the bullet head, such that compression of the head results in compression of the spring. The spring may comprise sufficient tension to prevent the hook and/or connection member from substantially extending out from the bullet casing unless the actuator is depressed. The spring may be adapted to comprise a tension for keeping an item within the hook and/or connection member, unless the actuator is depressed.

The hook member may comprise a material of sufficient strength to hold an item, such as the end of a zipper, when pulled by the zipper pull. The hook may comprise metal, plastic, wood, and/or the like. The hook member may be rounded, semi-rounded, square, or the like. The hook member may be bent in a hooked and/or rounded shape, so that the item may fit under the hook when the hook is extended past the back end portion of the zipper pull. The hook member may be attached to the rod at one end and may be forced outwardly by the rod when the head of the bullet is compressed. The hook member may retain the end of a zipper within the curved portion of the hook such that the end of the zipper does not move away from the zipper pull. As such, when the zipper pull is pulled upwardly or downwardly, the attached zipper is pulled upwardly or downwardly. In some embodiments, the zipper pull may comprise electrical communication components adapted to communicate with additional users. For example, the zipper pull may comprise a chip adapted to indicate a position of the zipper pull. In some embodiments, the zipper pull may comprise a lighting member, such as a flashlight or a beacon, to allow the user to see in darkened conditions and/or to allow other users to locate the position of the user.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein.

What is claimed is:

1. A cord lock assembly comprising:
a bullet casing comprising an opening;
a caming device comprising a shaft having a hole formed therethrough, the hole comprising the same size as the opening in the bullet casing, the hole adapted to accept a cord;
a rod attached to the caming device, the rod for moving the caming device between an open position and a closed position;
a button comprising a bullet primer, the button attached to the rod;
a spring for biasing the cam in the closed position until the rod is depressed by a user; and
a bullet head attached the casing.

2. The cord lock assembly of claim 1, wherein cord lock assembly comprises components of ammunition.
